(19) United States
(12) Patent Application Publication
(10) Pub. No.: US 2025/0274267 A1
(43) Pub. Date: Aug. 28, 2025

(54) ELECTRONIC DEVICE AND CONTROL METHOD THEREFOR

(71) Applicant: SAMSUNG ELECTRONICS CO., LTD., Suwon-si (KR)

(72) Inventors: Manoj Kumar SHARMA, Suwon-si (KR); Ankit Dhanuka, Suwon-si (KR)

(73) Assignee: SAMSUNG ELECTRONICS CO., LTD., Suwon-si (KR)

(21) Appl. No.: 19/188,640

(22) Filed: Apr. 24, 2025

Related U.S. Application Data
(63) Continuation of application No. PCT/KR2023/014230, filed on Sep. 20, 2023.

(30) Foreign Application Priority Data
Oct. 24, 2022 (KR) 10-2022-0137778

(51) Int. Cl. H04L 9/08; H04W 76/30; H04W 84/12

(52) U.S. Cl. CPC H04L 9/0819; H04W 76/30; H04W 84/12

(57) ABSTRACT

An electronic device includes a communication interface; one or more processors; and memory storing instructions that, when executed by the one or more processors, cause the electronic device to broadcast an advertising packet including identification information of the electronic device and a Wi-Fi MAC address; transmit an encrypted audio signal, to the audio device; based on receiving a request for Point-to-Point (P2P) from the terminal device, perform the P2P communication with the terminal device based on the Wi-Fi MAC address; and based on identifying a preset event has occurred for enabling transmission of an encryption key of the electronic device, transmit the encryption key to the terminal device by using the P2P communication, to cause the terminal device to transmit the encryption key to the audio device and to cause the audio device to decrypt the encrypted audio signal based on receiving the encryption key.

### CROSS-REFERENCE TO RELATED APPLICATION

This application is a by-pass continuation application of International Application No. PCT/KR2023/014230, filed on Sep. 20, 2023, which is based on and claims priority to Korean Patent Application No. 10-2022-0137778, filed on Oct. 24, 2022, in the Korean Intellectual Property Office, the disclosures of which are incorporated by reference herein in their entireties.

### BACKGROUND

### 1. Field

The present disclosure relates to an electronic device and a control method therefor and more to an electronic device transmitting an encrypted audio signal to an audio device and a control method therefor.

### 2. Description of Related Art

A TV may not directly output an audio signal but an external device (e.g. a headset) may output an audio signal. A user may listen to audio sound through a separate headset rather than a built-in speaker of the TV for a better performance or concentration under a quiet environment even though the TV itself includes a speaker.

To output the audio signal provided by the TV to the external device (headset), the audio signal provided by the TV should be encrypted and transmitted to the external device. An encryption key may be used to decrypt the encrypted audio signal, and the encryption key may be transmitted to an audio device.

If there is no input portion for manipulation in the external device (headset), it may be difficult to request the encryption key through the external device (headset).

If the external device (headset) is already connected to a terminal device (smart phone) via Bluetooth, it may be difficult for the TV to connect to the external device (headset) via Bluetooth communication. The TV may need a method for transmitting information (e.g. the encryption key) having security to the external device (headset).

### SUMMARY

According to an aspect of the disclosure, an electronic device includes a communication interface configured to communicate with a terminal device and an audio device; one or more processors; and memory storing instructions that, when executed by the one or more processors, cause the electronic device to broadcast, via the communication interface, an advertising packet including identification information of the electronic device and a Wi-Fi MAC address; transmit, via the communication interface, an encrypted audio signal, to the audio device; based on receiving, via the communication interface, a request for Point-to-Point (P2P) from the terminal device, perform, via the communication interface, the P2P communication with the terminal device based on the Wi-Fi MAC address; and based on identifying a preset event has occurred for enabling transmission of an encryption key of the electronic device, transmit, via the communication interface, the encryption key to the terminal device by using the P2P communication, to cause the terminal device to transmit the encryption key to the audio device and to cause the audio device to decrypt the encrypted audio signal based on receiving the encryption key.

The communication interface may include a Bluetooth Low Energy (BLE) communication interface, and the instructions, when executed by the one or more processors, may cause the electronic device to transmit the encrypted audio signal to the audio device via the BLE communication interface.

The instructions, when executed, by the one or more processors, may cause the electronic device to, based on the encryption key being transmitted to the terminal device, disconnect, via the communication interface, the P2P communication with the terminal device.

The instructions, when executed by the one or more processors, may cause the electronic device to transmit the encryption key to the terminal device, to cause the terminal device to transmit the encryption key to the audio device and to cause the audio device to decrypt the encrypted audio signal and output the decrypted audio signal based on receiving the encryption key.

The instructions, when executed by the one or more processors, may cause the electronic device to transmit the encryption key and sync data to the terminal device via the P2P communication, to cause the terminal device to transmit the sync data to the audio device and to cause the audio device to output the decrypted audio signal based on the sync data.

The electronic device may further include a display, and the instructions, when executed by the one or more processors, may cause the electronic device to, based on identifying the request for the P2P communication has been received by the terminal device, output, via the display, a User Interface (UI) for enabling the P2P communication with the terminal device; and based on a user input being received via the UI, perform the P2P communication, via the communication interface, with the terminal device based on the Wi-Fi MAC address.

The preset event may include at least one of a user input for transmitting the encryption key being received, identifying that the terminal device is a preregistered device, or identifying that the terminal device is the preregistered device and that the terminal device is within a preset distance from the electronic device.

The instructions, when executed by the one or more processors, may cause the electronic device to, based on a request for the encryption key being received from the terminal device, identify whether the preset event occurs.

The instructions, when executed by the one or more processors, may cause the electronic device to, based on identifying the preset event has occurred, generate guide information for the decrypted audio signal; and transmit, via the communication interface, the guide information and the encryption key to the terminal device, to cause the terminal device to transmit the guide information to the audio device.

The electronic device may further include a display, and the instructions, when executed by the one or more processors, may cause the electronic device to output the guide information via the display.

According to an aspect of the disclosure, a method of controlling an electronic device storing identification information of the electronic device, an encrypted audio signal, and an encryption key, includes broadcasting an advertising packet including the identification information and a Wi-Fi MAC address via a communication interface of the electronic device; transmitting the encrypted audio signal to an audio device via the communication interface; based on a request for Point-to-Point (P2P) communication being received from a terminal device, via the communication interface, performing the P2P communication with the terminal device based on the Wi-Fi MAC address; and based on identifying a preset event has occurred for enabling transmission of the encryption key, transmitting the encryption key to the terminal device via the P2P communication, to cause the terminal device to transmit the encryption key to the audio device and to cause the audio device to decrypt the encrypted audio signal based on receiving the encryption key.

The electronic device includes a Bluetooth Low Energy (BLE) communication interface, and the transmitting the encrypted audio signal may include transmitting the encrypted audio signal to the audio device via the BLE communication interface.

The method may further include, based on identifying the encryption key has been transmitted to the terminal device, disconnecting the P2P communication with the terminal device.

The transmitting the encrypted audio signal may include transmitting the encryption key to the terminal device, to cause the terminal device to transmit the encryption key to the audio device and to cause the audio device to decrypt the encrypted audio signal and output the decrypted audio signal based on receiving the encryption key.

The transmitting the encrypted audio signal may include transmitting the encryption key and sync data to the terminal device via the P2P communication, to cause the terminal device to transmit the sync data to the audio device and to cause the audio device to output the decrypted audio signal based on the sync data.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a view illustrating a system including an electronic device, a terminal device, and an audio device;

FIG. 2 is a block diagram illustrating an electronic device according to various embodiments;

FIG. 3 is a block diagram illustrating a detailed configuration of the electronic device of FIG. 2;

FIG. 4 is a flow chart illustrating an operation of transmitting an encrypted audio signal according to various embodiments;

FIG. 5 is a flow chart illustrating an operation of transmitting an encrypted audio signal according to various embodiments;

FIG. 6 is a flow chart illustrating an operation of transmitting an encrypted audio signal according to various embodiments;

FIG. 7 is a flow chart illustrating an operation of transmitting an encrypted audio signal according to various embodiments;

FIG. 8 is a flow chart illustrating an operation of transmitting an encrypted audio signal according to various embodiments;

FIG. 9 is a flow chart illustrating an operation of using sync data;

FIG. 10 is a flow chart illustrating an operation of displaying a guide UI for connecting an electronic device and a terminal device;

FIG. 11 is a view illustrating an operation of displaying a guide UI for connecting an electronic device and a terminal device;

FIG. 12 is a flow chart illustrating an operation of displaying a guide UI for connecting an electronic device and an audio device;

FIG. 13 is a view illustrating an operation of displaying a guide UI for connecting an electronic device and an audio device;

FIG. 14 is a flow chart illustrating an operation in which an audio device outputs guide information;

FIG. 15 is a view illustrating an operation in which an audio device outputs guide information;

FIG. 16 is a view illustrating an operation in which an electronic device outputs guide information;

FIG. 17 is a view illustrating an operation related to volume control;

FIG. 18 is a view illustrating a UI related to connection of an audio device according to various embodiments;

FIG. 19 is a view illustrating a UI related to connection of an audio device according to various embodiments; and

FIG. 20 is a flow chart illustrating a method of controlling an electronic device according to various embodiments.

### DETAILED DESCRIPTION

The embodiments described in the disclosure, and the configurations shown in the drawings, are only examples of embodiments, and various modifications may be made without departing from the scope and spirit of the disclosure.

The terms used with respect to various embodiments are selected as terms are used based on consideration of functions in the disclosure and terms of the relevant art, and such terms may be varied depending on the context of the term as provided in the disclosure. The terms used in the disclosure should be defined based on the meaning of the term and the entire content throughout the disclosure rather than simply the name of the term.

The expression such as “have”, “may have”, “include”, or “may include” denotes the existence of such a characteristic (e.g. a numerical value, a function, an operation, or a component such as a part) and does not exclude the existence of additional characteristics.

The expressions “at least one of A, B and C” and “at least one of A, B, or C”, both indicate “A”, only “B”, only “C”, both “A and B”, both “A and C”, both “B and C”, and all of “A, B, and C”.

The expression “1st”, “2nd”, “first”, “second”, or the like may be used to describe various elements regardless of any order and/or degree of importance, wherein such expression is used only to distinguish one element from another element and is not intended to limit the relevant element.

The description that one element (e.g. a first element) is “(operatively or communicatively) coupled with/to” or “connected to” another element (e.g. a second element) should be interpreted to include both of the case where the one element is directly coupled to the another element, and the case where the one element is coupled to the another element through the other element (e.g. a third element).

A singular expression includes a plural expression, unless obviously differently defined in the context. In the application, the term such as “include” or “consist of” should be construed as designating that there are such characteristics, numbers, steps, operations, components, parts, or a combination thereof described but not as excluding the existence or addition of one or more other characteristics, numbers, steps, operations, components, parts, or a combination thereof.

“module” or “part” may perform at least one function or operation and may be implemented as hardware or software, or as a combination of hardware and software. A plurality of “modules” or “parts” may be integrated into at least one module and implemented as at least one processor, excluding a “module” or a “part” that may be implemented as hardware.

The term “user” may refer to a person who uses an electronic device or a device that uses an electronic device (e.g. an Artificial Intelligence (AI) electronic device).

Various embodiments are described with reference to the appended drawings.

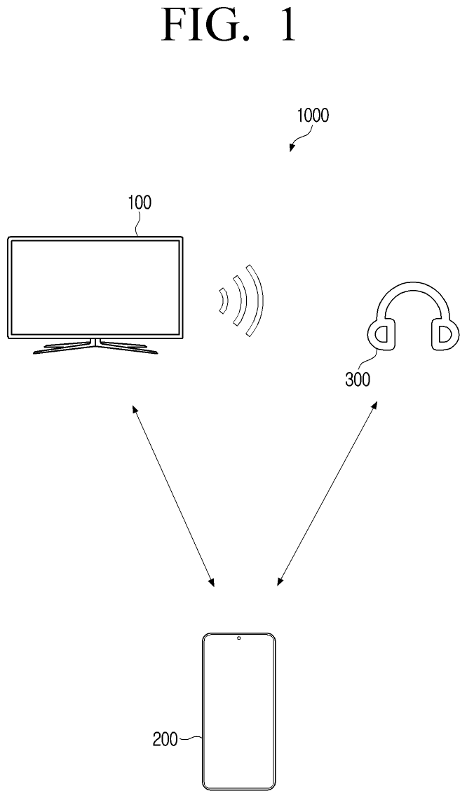

FIG. 1 is a view illustrating a system 1000 including an electronic device 100, a terminal device 200, and an audio device 300.

The system 1000 may include at least one of the electronic device 100, the terminal device 100, or the audio device 300.

The electronic device 100 may be a device providing a content. The electronic device 100 may be a device which includes a display and displays a content. For example, the electronic device 100 may be a TV.

The terminal device 200 may perform an operation of transmitting information between the electronic device 100 and the audio device 300. The electronic device 100 may be communicatively connected to the terminal device 200. The terminal device 200 may be communicatively connected to the audio device 300. The electronic device 100 may transmit information to the terminal device 200, and the terminal device 200 may transmit the received information to the audio device 300. On the contrary, the audio device 300 may transmit information to the terminal device 200, and the terminal device 200 may transmit the received information to the electronic device 100.

The electronic device 100 may transmit the audio signal to the audio device 300. The terminal device 200 may transmit information about the audio device 300 to the electronic device 100. The terminal device 200 may transmit information about the electronic device 100 to the audio device 300.

The electronic device 100 and the audio device 300 may not directly establish a communication session. For example, the electronic device 100 and the audio device 300 may not be connected via Bluetooth communication.

According to various embodiments, the terminal device 200 and the audio device 300 may be mutually connected via Bluetooth communication. The terminal device 200 and the audio device 300 may be mutually connected via Bluetooth communication, and the electronic device 100 and the terminal device 200 may transmit or receive information via a broadcasting operation or Wi-Fi communication. The electronic device 100 may not directly transmit information to the audio device 300. The electronic device 100 may transmit the information to the audio device 300 through a broadcasting method.

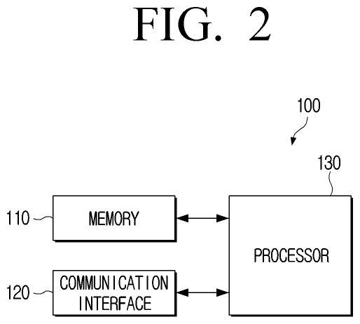

FIG. 2 is a block diagram illustrating an electronic device 100 according to various embodiments.

With reference to FIG. 2, the electronic device 100 may include at least one of memory 110, a communication interface 120, or at least one processor 130.

The memory 110 may store identification information of the electronic device 100, an encrypted audio signal, and an encryption key. The memory 110 may store an audio signal. The electronic device 100 may encrypt an audio signal at a time point when the audio signal is transmitted. The memory 110 may store an encrypted audio signal.

The communication interface 120 may perform communication with the terminal device 200 or the audio device 300.

The electronic device 100 may include a at least one processor 130 configured to control the communication interface 120 to broadcast an advertising packet including the identification information and a Wi-Fi MAC address, control the communication interface 120 to transmit the encrypted audio signal to the audio device 300, if a request for Wi-Fi P2P communication is received from the terminal device 200, control the communication interface 120 to perform the Wi-Fi P2P communication with the terminal device 200 based on the Wi-Fi MAC address, and if it is identified that a preset event occurs, control the communication interface 120 to transmit the encryption key to the terminal device 200 by using the Wi-Fi P2P communication, wherein the encryption key may be transmitted to the audio device 300 through the terminal device 200, and wherein the encrypted audio signal may be decrypted based on the encryption key.

The at least one processor 130 may control the communication interface 120 to transmit the encrypted audio signal to the audio device 300 by using a BLE communication interface.

The communication interface 120 may include the BLE communication interface.

The at least one processor 130 may broadcast an advertising packet including the identification information and a Wi-Fi MAC address by using the BLE communication interface.

The at least one processor 130 may transmit the encrypted audio signal to the external device through the BLE communication interface. The encrypted audio signal is not transmitted after connecting to a device via Bluetooth communication but may be transmitted such that the encrypted audio signal is transmitted to many and unspecified devices. According to various embodiments, the encrypted audio signal may be broadcasted. The encrypted audio signal may be broadcasted in a packet different from the advertising packet.

For convenience of division, an advertising packet including identification information of the electronic device 100 is described as a first packet, a packet including a Wi-Fi MAC address is described as a second packet, and a packet including the encrypted audio signal is described as a third packet.

The at least one processor 130 may broadcast each of a first packet, a second packet, and a third packet to be transmitted to many and unspecified devices.

According to various embodiments, the at least one processor 130 may broadcast the first packet, the second packet, and the third packet by using the BLE communication interface.

According to various embodiments, the at least one processor 130 may broadcast the first packet by using the BLE communication interface and may broadcast the second packet and the third packet through a Wi-Fi interface rather than the BLE communication interface.

According to various embodiments, all of the first packet, the second packet, and the third packet may be broadcasted through different communication interfaces.

The broadcasted advertising packet may include identification information of the electronic device 100. The advertising packet may include various parameter information for Bluetooth communication. The terminal device 200 receiving the advertising packet may identify the electronic device 100 which broadcasts the advertising packet based on parameter information included in the advertising packet.

Here, the terminal device 200 receiving the advertising packet may recognize that it may be to communicate with the electronic device 100. The terminal device 200 may obtain the identification information of the electronic device 100 included in Wi-Fi P2P.

The terminal device 200 may try to connect to the electronic device 100 via Wi-Fi P2P communication based on the advertising packet. The terminal device 200 may transmit a Wi-Fi MAC address.

The at least one processor 130 may receive the Wi-Fi MAC address from the terminal device 200. The at least one processor 130 may determine to connect to the terminal device 200 via the Wi-Fi P2P communication based on the received Wi-Fi MAC address. The at least one processor 130 may generate a signal which approves the Wi-Fi P2P communication and transmit the generated approval signal to the terminal device 200. The electronic device 100 and the terminal device 200 may be mutually connected via the Wi-Fi P2P communication.

The communication interface 120 of the electronic device 100 may include a first communication interface (Bluetooth communication interface) and a second communication interface (Wi-Fi communication interface). The at least one processor 130 may broadcast the first packet, the second packet, and the third packet through the first communication interface. The at least one processor 130 may be connected to the terminal device 200 via the Wi-Fi P2P communication through the second communication interface. Security related to the encryption key transmission may be increased by using different communication interfaces. Even though there is a hacking attempt or an interference attempt to the Bluetooth communication, the encryption key may be safely transmitted to the terminal device 200.

After the electronic device 100 and the terminal device 200 are mutually connected via the Wi-Fi P2P communication, the at least one processor 130 may identify whether a preset event occurs.

The preset event may mean an event for enabling transmission of an encryption key stored in the electronic device 100 to the audio device 300. The preset event may be determined and changed according to a user setting.

The preset event may include at least one of an event that a user input for transmitting the encryption key is received, an event that the terminal device 200 requesting the encryption key is a preregistered device, or an event that the terminal device 200 is the preregistered device and the terminal device 200 is within a threshold distance (or a preset distance) from the electronic device 100.

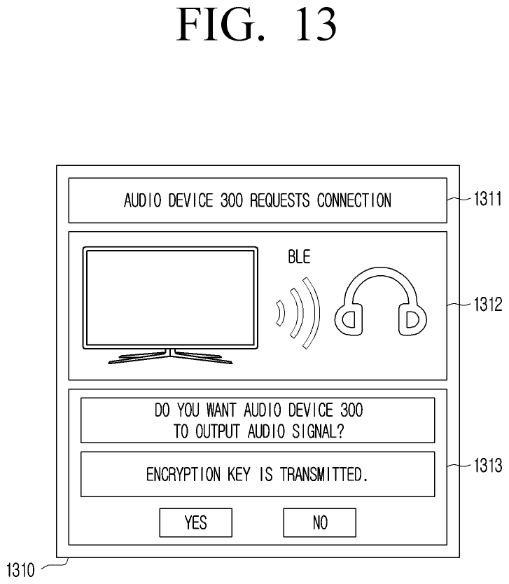

The event that the user input for transmitting the encryption key is received may be an event that the user directly inputs a command for transmitting the encryption key to the audio device 300. For example, the user may input the user command to the electronic device 100 through a physical button of the electronic device 100 or a remote control device for controlling the electronic device 100. The operation of directly inputting the user command is described in FIG. 13.

The event that the terminal device 200 requesting the encryption key is the preregistered device may means an event that the terminal device 200 is included in a plurality of preregistered devices. The electronic device 100 may store a registration device list including the plurality of preregistered devices in the memory 110. The plurality of preregistered devices may mean a device which has a record of connecting to the at least one processor 130 or a device to which access is approved by the user. The registration device list stored in the memory 110 of the electronic device 100 may store identification information (e.g. a unique number) which may distinguish a registration device.

The at least one processor 130 may receive identification information of the terminal device 200 together with the encryption key from the terminal device 200. The at least one processor 130 may determine whether the identification information of the terminal device 200 is included in the registration device list. If the identification information of the terminal device 200 is included in the registration device list, the at least one processor 130 may determine that the preset event occurs. If the identification information of the terminal device 200 is not transmitted together with the encryption key, the at least one processor 130 may separately request identification information from the terminal device 200.

The encryption key and the identification information of the terminal device 200 may be stored in one packet. The one packet may be described as an encryption key request packet. The encryption key may be stored in a first area of the encryption key request packet, and the identification information of the terminal device 200 may be stored in a second area (an area different from the first area) of the packet. The terminal device 200 may generate an encryption key request packet including a signal requesting the encryption key and the identification information of the terminal device 200 and may transmit the generated encryption key request packet to the electronic device 100.

The at least one processor 130 may receive the encryption key request packet from the terminal device 200. The at least one processor 130 may obtain the signal requesting the encryption key in the first area of the encryption key request packet. The at least one processor 130 may analyze the obtained signal requesting the encryption key and identify that the terminal device 200 requests the encryption key. The at least one processor 130 may obtain the identification information of the terminal device 200 in the second area of the encryption key request packet. The at least one processor 130 may determine whether the identification information of the obtained terminal device 200 is included in the registration device list. If the identification information of the terminal device 200 is included among a plurality of identification information included in the registration device list, the at least one processor 130 may determine that the preset event occurs.

The event that the terminal device 200 is the preregistered device and the terminal device 200 is within a threshold distance (or a preset distance) from the electronic device 100 may be an event that the registered device is within the threshold distance (or the preset distance) with reference to the electronic device 100. Even though the identification information of the terminal device 200 is not included in the registration device list, the encryption key transmission may not be performed. To increase security, the electronic device 100 may additionally confirm a position of the terminal device 200 besides an operation of confirming the identification information of the terminal device 200. The at least one processor 130 may receive position information of the terminal device 200.

According to various embodiments, the position information of the terminal device 200 may be stored in a third area of the encryption key request packet. The at least one processor 130 may obtain a distance value between the electronic device 100 and the terminal device 200 based on the position information of the terminal device 200. If the obtained distance value is less than a threshold value, the at least one processor 130 may identify that the preset event occurs.

According to various embodiments, the position information of the terminal device 200 may be determined based on signal strength (intensity) of the encryption key request packet transmitted by the terminal device 200. The at least one processor 130 may identify the signal strength of the encryption key request packet. If the signal strength of the encryption key request packet is equal to or greater than a threshold value, the at least one processor 130 may identify that the preset event occurs.

If it is identified that the preset event occurs, the at least one processor 130 may control the communication interface 120 to transmit the encryption key to the terminal device 200 by using the Wi-Fi P2P communication.

The terminal device 200 may receive the encryption key from the electronic device 100. The terminal device 200 may transmit the received encryption key to the audio device 300.

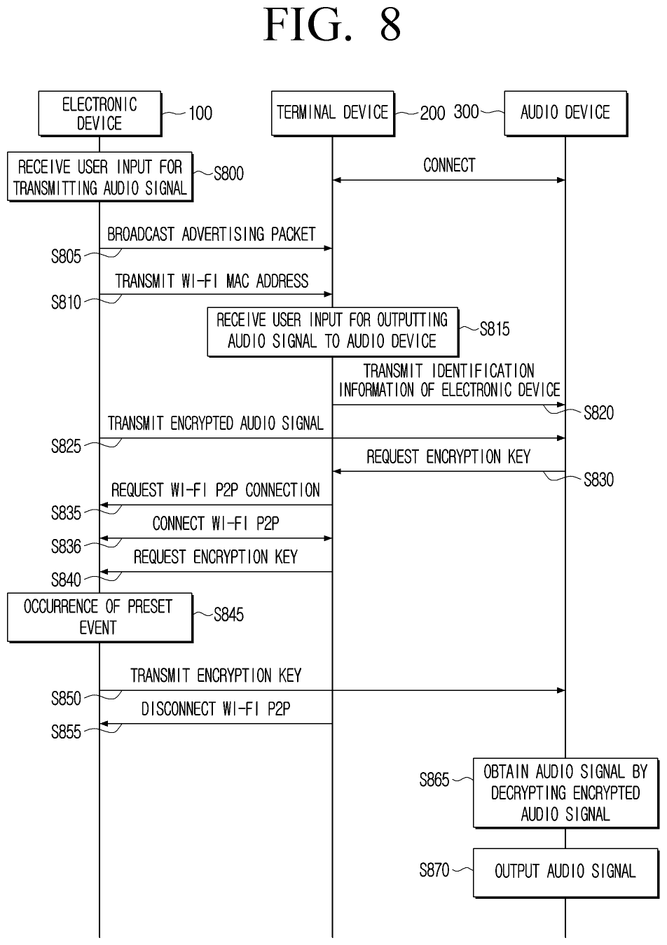

The reason that the electronic device 100 transmits it to the audio device 300 through the terminal device 200 is because a communication session having security is not established between the electronic device 100 and the audio device 300. The encrypted audio signal is information which may not use additional security, and thus may be transmitted in a broadcasting method. If the encryption key is transmitted in the broadcasting method, a meaning for the encryption operation itself may disappear. The electronic device 100 may selectively transmit the encryption key only to the audio device 300 through the terminal device 200. An example that the electronic device 100 transmits the encryption key to the audio device 300 is described in FIG. 8. Additional authentication operations for security may be used.

The audio device 300 may receive the encryption key. The audio device 300 may decrypt the encrypted audio signal received before, based on the received encryption key. As a result of the decryption operation, the audio device 300 may obtain the decrypted audio signal. The audio device 300 may output an audio signal. The audio device 300 may include a speaker or headset, and the audio device 300 may output the audio signal through the speaker or headset.

The at least one processor 130, if transmitting the encryption key to the terminal device 200, may control the communication interface 120 to disconnect Wi-Fi P2P communication with the terminal device 200.

The Wi-Fi P2P communication may be used for the encryption key transmission operation. If the encryption key transmission is completed, the at least one processor 130 may terminate the Wi-Fi P2P. It is for preventing waste of resources and power.

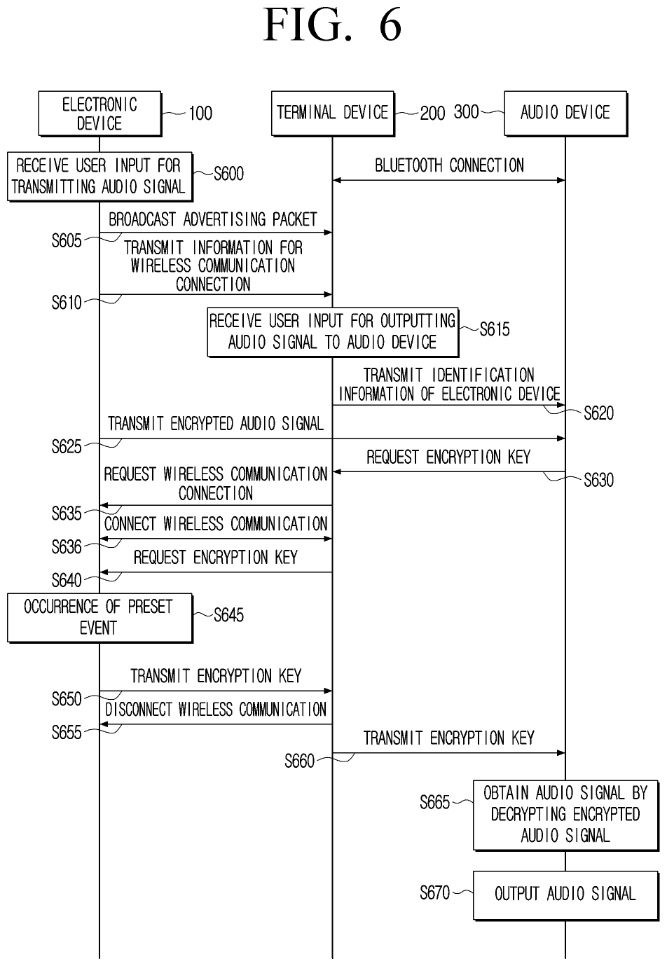

The encrypted audio signal may include an audio signal, wherein the audio signal is a signal output by the audio device 300 after being obtained from the encrypted audio signal. The description related to the above is described in FIG. 6.

The at least one processor 130 may transmit the encryption key and sync data to the terminal device 200 by using the Wi-Fi P2P communication, the sync data may be transmitted to the audio device 300 through the terminal device 200, and the audio signal may be a signal output by the audio device 300 based on the sync data.

According to various embodiments, the at least one processor 130 may transmit the encryption key and the sync data together to the terminal device 200. The encryption key and the sync data may be included in one packet (an encryption key transmission packet).

According to various embodiments, the at least one processor 130 may transmit only the sync data to the terminal device 200 separately from the encryption key transmission.

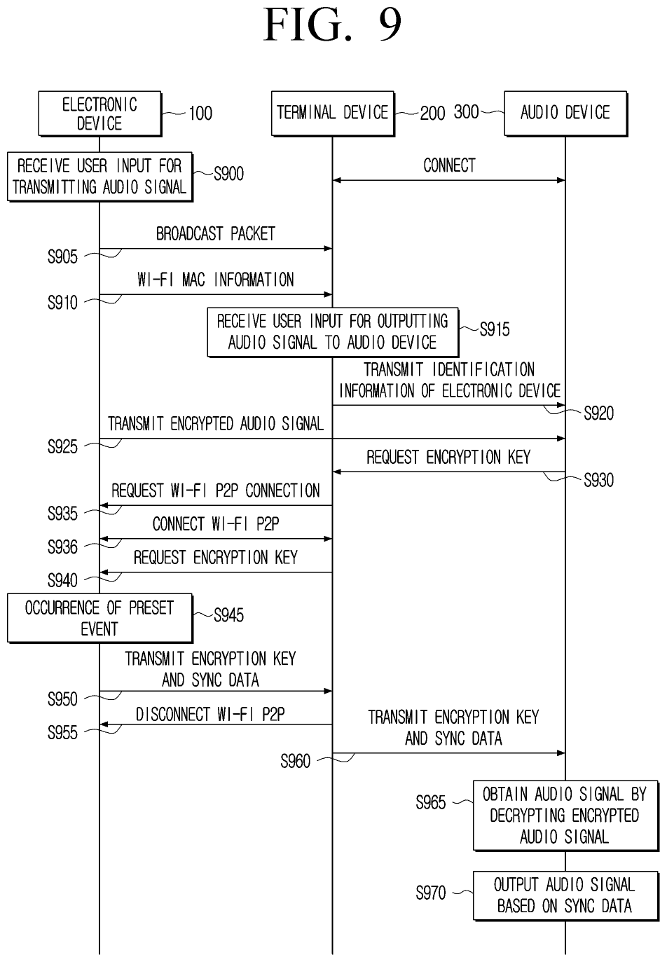

According to various embodiments, the at least one processor 130 may transmit the sync data to the audio device 300. The sync data corresponds to information of which security is low, and thus the electronic device 100 may directly transmit it to the audio device 300. For example, the sync data may be transmitted to the audio device 300 in the same way as the way that the encrypted audio signal is transmitted to the audio device 300. The additional description related to the sync data is described in FIG. 9.

The electronic device 100 may further include a display 140.

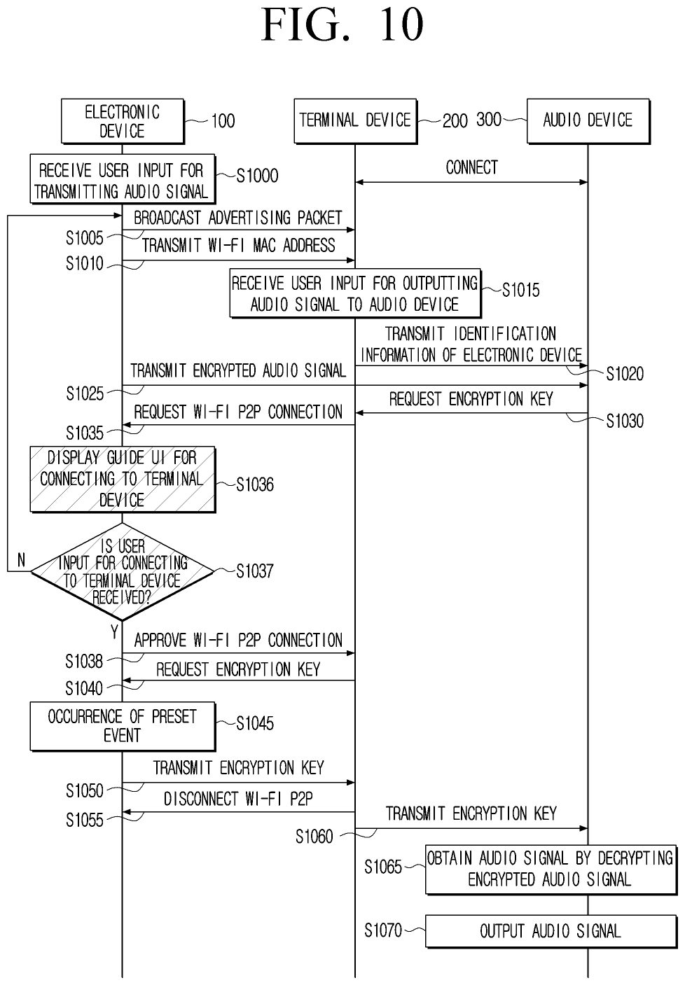

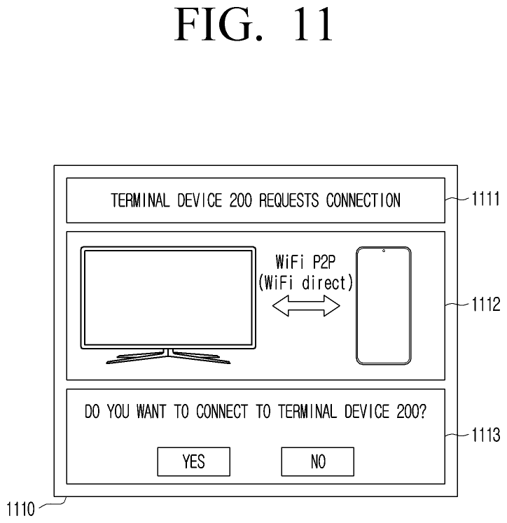

The at least one processor 130, if receiving a request for Wi-Fi P2P communication from the terminal device 200, may control the display 140 to display a guide UI for enabling the Wi-Fi P2P communication with the terminal device 200, and if receiving a user input through the guide UI, may control the communication interface 120 to perform the Wi-Fi P2P communication with terminal device 200 based on the Wi-Fi MAC address. The detailed description related to the above is described in FIGS. 10 and 11.

The at least one processor 130, if a request for the encryption key is received from the terminal device 200, may identify whether the preset event occurs.

If the request for the encryption key is not received, the at least one processor 130 may not identify whether the preset event occurs. If there is no request for the encryption key, the electronic device 100 may not determine the preset event to save resources.

In the electronic device 100, the at least one processor 130, if identifying that the preset event occurs, may generate guide information indicating that the audio signal is output by the audio device 300 and control the communication interface 120 to transmit the generated guide information and the encryption key to the terminal device 200, wherein the guide information is transmitted to the audio device 300 through the terminal device 200.

The at least one processor 130 may control the display 140 to display the guide information.

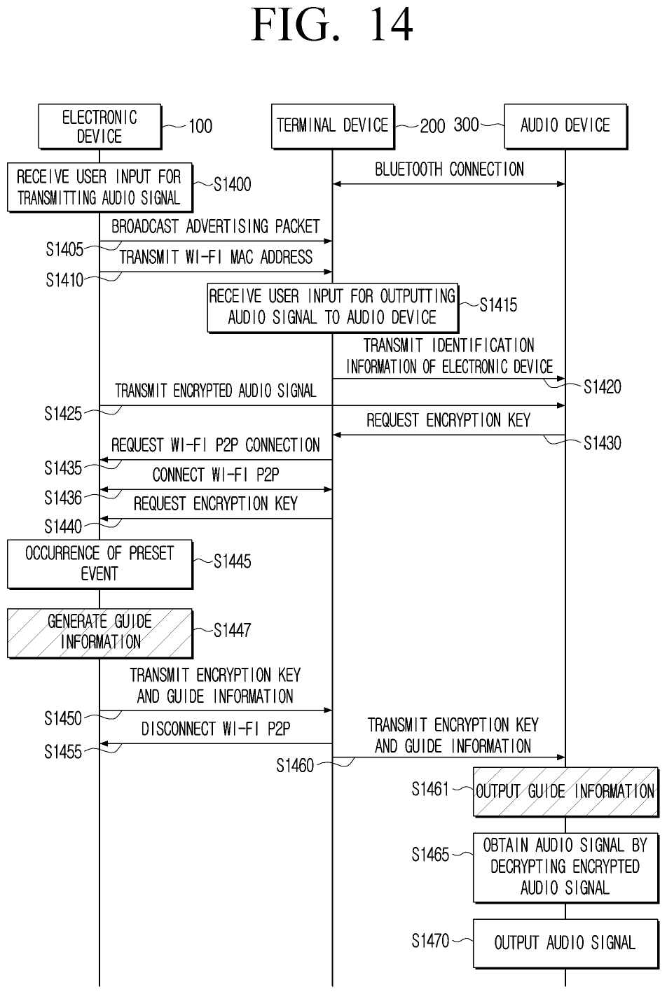

The additional description related to the guide information is described in FIGS. 14 to 16.

According to various embodiments, the electronic device 100 transmits the encrypted audio signal to the audio device 300 and transmits the encryption key through the terminal device 200. Here, the encrypted audio signal may be transmitted by using a first communication method (e.g. Bluetooth communication), and the encryption key may be transmitted by using a second communication method (e.g. Wi-Fi communication). Security may be increased by using different communication methods.

According to various embodiments, the electronic device 100 may not directly transmit the encryption key to the audio device 300 but may transmit the encryption key to the audio device 300 through the terminal device 200. The audio device 300 merely connects to the terminal device 200 and the audio device 300 does not connect to the electronic device 100, and thus the electronic device 100 may transmit the encryption key to the audio device 300 through the terminal device 200. The encryption key may be safely transmitted to the audio device 300 by using the terminal device 200.

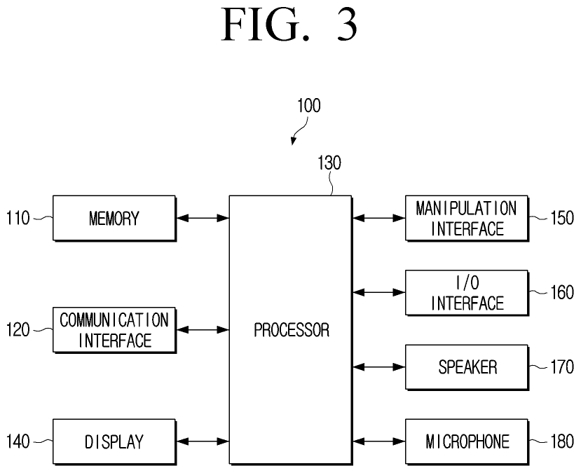

FIG. 3 is a block diagram illustrating a detailed configuration of the electronic device 100 of FIG. 2.

With reference to FIG. 3, the electronic device 100 may include at least one of memory 110, a communication interface 120, at least one processor 130, a display 140, a manipulation interface 150, an input/output (I/O) interface 160, a speaker 170, or a microphone 180. For additional implementation details, reference may be made to the descriptions of FIG. 2.

According to various embodiments, the electronic device 100 may include, for example, at least one of a smart phone, a tablet PC, a mobile phone, a desktop PC, a laptop PC, a PDA, or a portable multimedia player (PMP). In some examples, the electronic device 100 may include, for example, at least one of a television, a digital video disk (DVD) player, or a media box (e.g. Samsung HomeSync™, Apple TV™, or Google TV™).

The memory 110 may be implemented as internal memory such as ROM (e.g. electrically erasable programmable read-only memory (EEPROM)) or RAM included in the processor 130 or may be implemented as memory separate from the processor 130. The memory 110 may be implemented as memory embedded in an electronic device 100 according to a use for data storage or may be implemented as memory detachable from the electronic device 100. For example, data for driving the electronic device 100 is stored in memory embedded in the electronic device 100 and data for an extension function of the electronic device 100 may be stored in memory detachable from the electronic device 100.

Memory embedded in the electronic device 100 may be implemented as at least one of volatile memory (e.g. dynamic RAM (DRAM), static RAM (SRAM), or synchronous dynamic RAM (SDRAM), for example) or non-volatile memory (e.g. one time programmable ROM (OTPROM), programmable ROM (PROM), erasable and programmable ROM (EPROM), electrically erasable and programmable ROM (EEPROM), mask ROM, flash ROM, flash memory (NAND flash or NOR flash, for example), a hard drive, or a solid state drive (SSD), and memory detachable from the electronic device 100 may be implemented as a memory card (a compact flash (CF) card, a secure digital (SD) card, a micro secure digital (Micro-SD) card, a mini secure digital (Mini-SD) card, an extreme digital (xD) card, or a multi-media card (MMC), for example), external memory connectible to a USB port (e.g., USB memory), or the like.

The communication interface 120 is a configuration performing communication with various types of external devices according to various types of communication methods. The communication interface 120 may include a wireless communication interface or a wired communication interface. Here, each communication interface may be implemented in a form of at least one hardware chip.

The wireless communication interface may be a interface which communicates with an external device wirelessly. For example, the wireless communication interface may include at least one interface of a Wi-Fi interface, a Bluetooth interface, an infrared communication interface, or other communication interfaces.

The Wi-Fi interface and the Bluetooth interface may perform communication in a Wi-Fi method and a Bluetooth method, respectively. In case of using the Wi-Fi interface or the Bluetooth interface, the interface may transmit or receive various connection information such as a service set identifier (SSID) and a session key in advance, connect communication by using the connection information, and then transmit or receive various information.

The infrared communication interface may perform communication based on an infrared data association (IrDA) technology which transmits data wirelessly in a short distance by using infrared light between visible light and a millimeter wave.

The other communication interfaces may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G) besides the communication methods.

The wired communication interface may be a interface which communicates with an external device wiredly. For example, the wire communication interface may include at least one of a Local Area Network (LAN) interface, an Ethernet interface, a pair cable, a coaxial cable, a fiber optic cable, or an Ultra Wide-Band (UWB) interface.

The processor 130 may be implemented as a digital signal processor (DSP) processing a digital signal, a microprocessor, or a time controller (TCON). The processor is not limited thereto and may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machine (ARM) processor or may be defined based on the relevant terms. The processor 130 may be implemented as a system on chip (SoC) in which a processing algorithm is embedded or a large scale integration (LSI) and may be implemented in a form of a field programmable gate array (FPGA). The processor 130 may perform various functions by executing computer executable instructions stored in the memory.

The display 140 may be implemented as a display having various forms such as a liquid crystal display (LCD), an organic light emitting diode (OLED) display, and a plasma display panel (PDP). The display 140 may include a driving circuit which may be implemented in a form such as an amorphous silicon thin film transistor (a-si TFT), a low temperature poly silicon (LTPS) TFT, or an organic TFT (OTFT), a backlight unit, or the like together therein. The display 140 may be implemented as a touch screen coupled to a touch sensor, a flexible display, a three-dimensional display (a 3D display), or the like. According to an embodiment, the display 140 may include not only a display panel outputting an image but also a bezel housing the display panel. According to an embodiment, the bezel may include a touch sensor for sensing a user interaction.

According to various embodiments, the electronic device 100 may include a display 140. The electronic device 100 may directly display the obtained image or content on the display 140.

According to various embodiments, the electronic device 100 may not include the display 140. The electronic device 100 may be connected to the external display device and may transmit an image or a content stored in the electronic device 100 to the external display device. The electronic device 100 may transmit the image or content together with the control signal for controlling the external display device to display the image or content to the external display device. Here, the external display device may be connected to the electronic device 100 through the communication interface 120 or an input/output (I/O) interface 160. For example, the electronic device 100 may not include a display such as a Set Top Box (STB). The electronic device 100 may include only a small display which may display information such as text information. Here, the electronic device 100 may transmit the image or content to the external display device wiredly or wirelessly through the communication interface 120 or may transmit the same to the external display device through the I/O interface 160.

The manipulation interface 150 may be implemented as a device such as a button, a touch pad, a mouse, and a keyboard or may be also implemented as a touch screen capable of performing the display function together with an input function for manipulation. Here, the button may be various types of buttons such as a mechanical button, a touch pad, or a wheel formed at any area such as a front part, a side part, a rear part, or the like of an appearance of a body of the electronic device 100.

The I/O interface 160 may be any one interface of a High Definition Multimedia Interface (HDMI), a Mobile High-Definition Link (MHL), a Universal Serial Bus (USB), a Display Port (DP), a Thunderbolt, a Video Graphics Array (VGA) port, a RGB port, D-subminiature (D-SUB), or a Digital Visual Interface (DVI). The I/O interface 160 may input and output at least one of an audio signal and a video signal. According to an embodiment, the I/O interface 160 may include a port which inputs or outputs only the audio signal and a port which inputs or outputs only the video signal as separate ports or may be implemented as one port which inputs or outputs all of the audio signal and the video signal. The electronic device 100 may transmit at least one of the audio signal and the video signal to the external device (e.g. an external display device or an external speaker) through the I/O interface 160. The output port included in the I/O interface 160 may be connected to the external device, and the electronic device 100 may transmit at least one of the audio signal and the video signal to the external device through an output port.

Here, the I/O interface 160 may be connected to a communication interface. The I/O interface 160 may transmit information received from the external device to the communication interface or may transmit information received through the communication interface to the external device.

The speaker 170 may be a component outputting not only various audio data but also various alarm sound, voice messages, or the like.

The microphone 180 is a component for receiving and converting a user voice or other sound to audio data. The microphone 180 may receive the user voice in an active state. For example, the microphone 180 may be formed as an integral type as being integrated into an upper side of the electronic device 100 or in a front direction, a side direction thereof, or the like. The microphone 180 may include various components such as a microphone collecting a user voice in an analog form, an amplifier circuit amplifying the collected user voice, an A/D conversion circuit sampling and converting the amplified user voice to a digital signal, and a filter circuit removing a noise component from the converted digital signal.

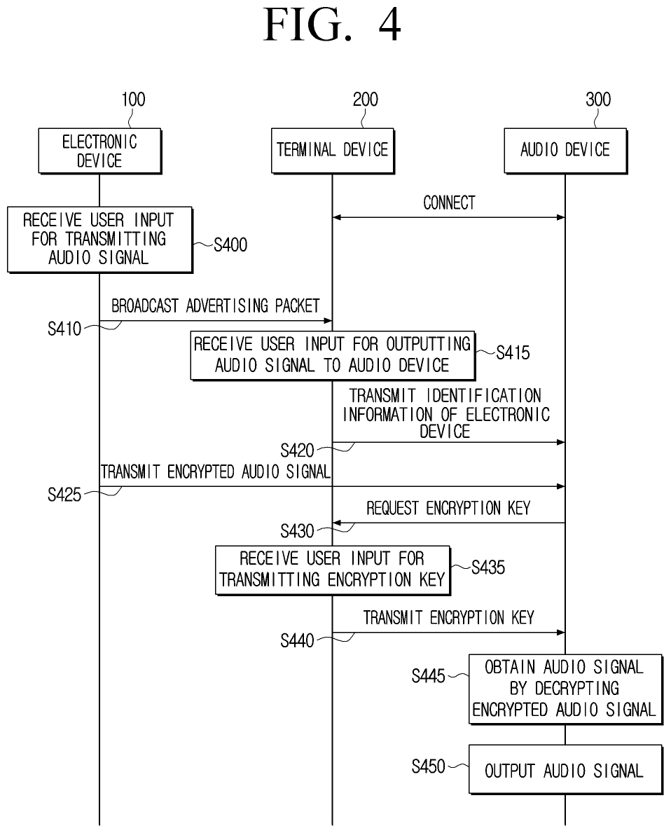

FIG. 4 is a flow chart illustrating an operation of transmitting an encrypted audio signal according to various embodiments.

With reference to FIG. 4, the terminal device 200 may be communicatively connected to the audio device 300. The electronic device 100 may receive a user input for transmitting an audio signal (S400). The user input may include a command that the electronic device 100 broadcasts an audio signal. If the user input is received, the electronic device 100 may broadcast an advertising packet. The advertising packet may include information related to the electronic device 100. For example, the information related to the electronic device 100 may include at least one of identification information or program information of the electronic device 100. The program information may include a program name related to an audio output or a program command, for example.

The terminal device 200 may receive the advertising packet transmitted by the electronic device 100. The terminal device 200 may obtain identification information of the electronic device 100 included in the received advertising packet.

After receiving the advertising packet, the terminal device 200 may receive a user input for outputting an audio signal (a TV audio signal) of the electronic device 100 to the audio device (S415).

The terminal device 200 may transmit identification information of the electronic device 100 to the audio device 300 (S420).

After broadcasting the advertising packet, the electronic device 100 may transmit the encrypted audio signal to the audio device 300 (S425).

The audio device 300 may receive the encrypted audio signal from the electronic device 100. If the encrypted audio signal is received, the audio device 300 may request an encryption key from the terminal device 200 (S430). The audio device 300 may transmit a control signal for requesting the encryption key to the terminal device 200.

The terminal device 200 may receive the request for the encryption key from the audio device 300. After receiving the request for the encryption key from the audio device 300, the terminal device 200 may receive a user input for transmitting the encryption key (S435). If the user input for transmitting the encryption key is received, the terminal device 200 may transmit the encryption key to the audio device 300 (S440).

The audio device 300 may receive the encryption key from the terminal device 200. The audio device 300 may obtain the audio signal by decrypting the encrypted audio signal received in the step S425 (S445).

The audio device 300 may output the audio signal (S450). The audio device 300 may obtain the audio signal from the encrypted audio signal through a decryption operation. The audio device 300 may output the decrypted audio signal.

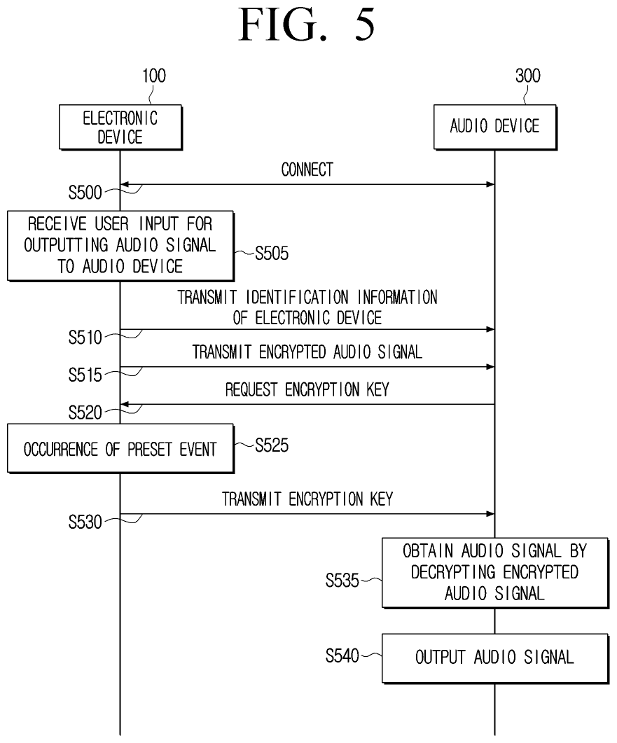

FIG. 5 is a flow chart illustrating an operation of transmitting an encrypted audio signal according to various embodiments.

With reference to FIG. 5, an electronic device 100 and an audio device 300 may be mutually and communicatively connected (S500). The electronic device 100 may receive a user input for outputting an audio signal to the electronic device 100 (S505). If the user input is received, the electronic device 100 may transmit identification information of the electronic device 100 to the audio device 300 (S510). The electronic device 100 may transmit the encrypted audio signal (S515).

The audio device 300 may receive the encrypted audio signal from the terminal device 200. If the encrypted audio signal is received, the audio device 300 may request an encryption key from the terminal device 100 (S520).

The electronic device 100 may receive the request for the encryption key from the audio device 300. After receiving the request for the encryption key, the electronic device 100 may identify occurrence of the preset event (S525). If the preset event occurs, the electronic device 100 may transmit the encryption key to the audio device 300

The audio device 300 may receive the encryption key from the electronic device 100. The audio device 300 may obtain the audio signal by decrypting the encrypted audio signal received in the step S515 (S535). The audio device 300 may output the audio signal (S540).

FIG. 6 is a flow chart illustrating an operation of transmitting an encrypted audio signal according to various embodiments.

The terminal device 200 of FIG. 6 may be communicatively connected to the audio device 300 via Bluetooth communication. The electronic device 100 may receive a user input for transmitting an audio signal (S600). If the user input is received, the electronic device 100 may broadcast an advertising packet (S605). The advertising packet may include identification information related to the electronic device 100. The electronic device 100 may transmit information for wireless communication connection to the terminal device 200 (S610).

The terminal device 200 may receive the information for wireless communication connection from the electronic device 100. After receiving the information for wireless communication connection, the terminal device 200 may receive a user input for outputting the audio signal to the audio device 300 (S615). If the user input for outputting the audio signal to the audio device 300 is received, the terminal device 200 may transmit identification information of the electronic device 100 to the audio device 300.

The electronic device 100 may transmit the encrypted audio signal to the audio device 300 (S625). The audio device 300 may identify the encrypted audio signal transmitted by the electronic device 100 based on the identification information of the electronic device 100 received from the terminal device 200. If the encrypted audio signal is received from the electronic device 100, the audio device 300 may request an encryption key from the terminal device 200 (S630).

The terminal device 200 may receive the encryption key from the audio device 300. If the encryption key is received, the terminal device 200 may request wireless communication connection from the electronic device 100 (S635). The terminal device 200 may generate a control signal for requesting wireless communication connection with the electronic device 100 and transmit the generated control signal to the electronic device 100.

The electronic device 100 may receive the request for wireless communication connection from the terminal device 200. If the request for wireless communication connection is received, the electronic device 100 may perform wireless communication connection with the terminal device 200 (S636).

If the electronic device 100 and the terminal device 200 perform wireless communication connection, the terminal device 200 may request the encryption key from the electronic device 100 (S640). The terminal device 200 may generate a control signal for requesting the encryption key and transmit the generated control signal to the electronic device 100.

The electronic device 100 may receive the request for the encryption key from the terminal device 200. After receiving the request for the encryption key, the electronic device 100 may identify occurrence of the preset event (S645). The preset event may be an event for transmitting the encryption key. The preset event may be varied according to a user setting.

The preset event may include at least one of an event that a user input for transmitting the encryption key through the UI is received, an event that a device requesting the encryption key is a preregistered device, or an event that it is identified that the preregistered device is within a threshold distance (or a preset distance) from the electronic device 100.

If the preset event occurs, the electronic device 100 may transmit the encryption key to the terminal device 200 (S650).

The terminal device 200 may receive the encryption key from the electronic device 100. If the encryption key is received, the terminal device 200 may transmit a signal for disconnecting the wireless communication to the electronic device 100 (S655). The wireless communication between the electronic device 100 and the terminal device 200 may be disconnected. If the encryption key is received, the terminal device 200 may transmit the encryption key to the audio device 300.

The audio device 300 may receive the encryption key from the terminal device 200. If the encryption key is received, the audio device 300 may obtain the audio signal by decrypting the encrypted audio signal received in the step S625 (S665). The audio device 300 may output the audio signal obtained through the decryption operation (S670).

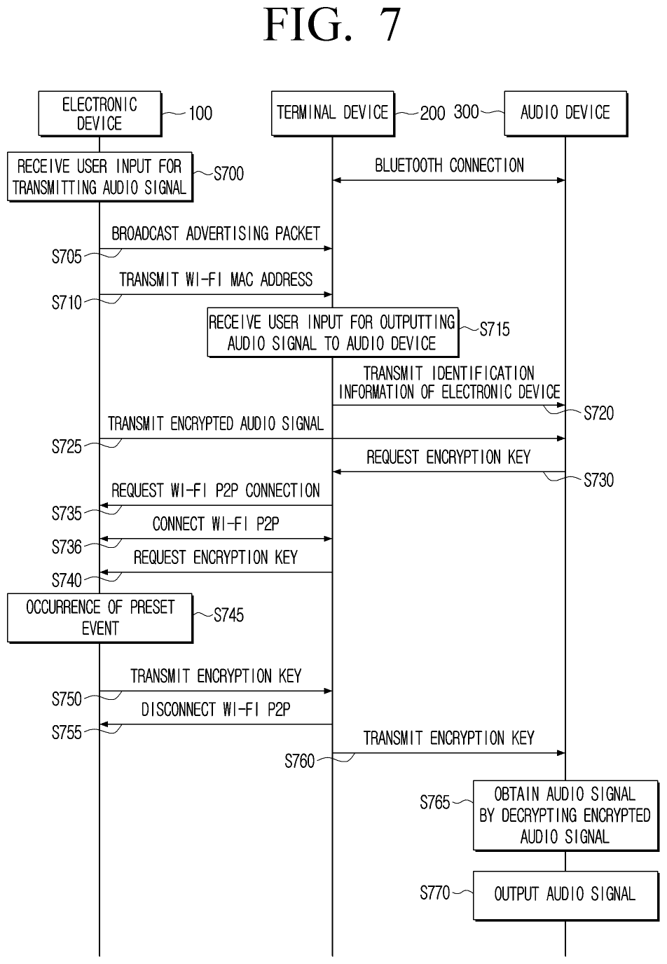

FIG. 7 is a flow chart illustrating an operation of transmitting an encrypted audio signal according to various embodiments.

The steps S700, S705, S710, S715, S720, S725, S730, S735, S736, S740, S745, S750, S755, S760, S765, S770 of FIG. 7 may correspond to the steps S600, S605, S610, S615, S620, S625, S630, S635, S636, S640, S645, S650, S655, S660, S665, S670. For additional implementation details, reference may be made to the descriptions of FIG. 6.

In an embodiment of FIG. 7, wireless communication connection may be Wi-Fi P2P connection. After broadcasting the advertising packet, the electronic device 100 may transmit the Wi-Fi MAC address to the terminal device 200 (S710). The steps S720 to S730 may be performed. The Wi-Fi P2P may be described as Wi-Fi Direct.

If receiving a request for the encryption key from the audio device 300, the terminal device 200 may transmit a signal requesting Wi-Fi P2P connection to the electronic device 100 based on the received Wi-Fi MAC address (S735).

After receiving a signal requesting Wi-Fi P2P connection, the electronic device 100 and the terminal device 200 may be connected via Wi-Fi P2P based on the Wi-Fi MAC address (S736). If the preset event occurs, the electronic device 100 may transmit the encryption key to the terminal device 200.

If the terminal device 200 receives the encryption key from the electronic device 100, the terminal device 200 may transmit a signal for disconnecting Wi-Fi P2P to the electronic device 100 (S755). The steps S760 to S770 may be performed.

FIG. 8 is a flow chart illustrating an operation of transmitting an encrypted audio signal according to various embodiments.

The steps S800, S805, S810, S815, S820, S825, S830, S835, S836, S840, S845, S865, S870 of FIG. 8 may correspond to the steps S700, S705, S710, S715, S720, S725, S730, S735, S736, S740, S745, S765, S770 of FIG. 7. For additional implementation details, reference may be made to the descriptions of FIG. 7.

If the preset event occurs, wherein the electronic device 100 may transmit the encryption key to the audio device 300 (S850). After transmitting the encryption key to the audio device 300, the electronic device 100 may transmit a signal for disconnecting Wi-Fi P2P to the terminal device 200 (S855). Information for directly transmitting the encryption key from the electronic device 100 to the audio device 300 may be transmitted or received through Wi-Fi P2P between the electronic device 100 and the terminal device 200. If the encryption key is directly transmitted to the audio device 300, an additional authentication operation may be used to increase security. The electronic device 100 may request an additional authentication from the terminal device 200 and may determine whether the authentication succeeds based on information (e.g. a password) received from the terminal device 200. If the authentication succeeds, the electronic device 100 may transmit the encryption key to the audio device 300.

FIG. 9 is a flow chart illustrating an operation of using sync data.

The steps S900, S905, S910, S915, S920, S925, S930, S935, S936, S945, S950, S955, S960, S965, S970 of FIG. 9 may correspond to the steps S700, S705, S710, S715, S720, S725, S730, S735, S736, S745, S750, S755, S760, S765, S770 of FIG. 7.

If the preset event occurs, the electronic device 100 may transmit the encryption key and sync data to the terminal device 200 (S950).

The terminal device 200 may receive the encryption key and the sync data from the electronic device 100. If the encryption key and the sync data are received, the terminal device 200 may transmit a control signal for disconnecting Wi-Fi P2P to the electronic device 100 (S955). If the encryption key and the sync data are received, the terminal device 200 may transmit the encryption key and the sync data to the audio device 300 (S960).

The audio device 300 may receive the encryption key and the sync data from the terminal device 200. The audio device 300 may obtain the audio signal by decrypting the encrypted audio signal obtained in the step S925 (S965). The audio device 300 may output the audio signal based on the sync data obtained in the step S960 (S970). In case of using the sync data, the audio device 300 may output the audio signal at a time point for output intended by the electronic device 100.

FIG. 10 is a flow chart illustrating an operation of displaying a guide UI for connecting an electronic device 100 and a terminal device 200.

The steps S1000, S1005, S1010, S1015, S1020, S1025, S1030, S1035, S1040, S1045, S1050, S1050, S1055, S1060, S1065, S1070 of FIG. 10 may correspond to the steps S700, S705, S710, S715, S720, S725, S730, S735, S740, S745, S750, S750, S755, S760, S765, S770 of FIG. 7.

If a request for connecting via Wi-Fi P2P is received from the terminal device 200, the electronic device 100 may display a guide UI for connecting to the terminal device 200 (S1036). The electronic device 100 may identify whether a user input for connecting to the terminal device 200 is received through the displayed guide UI (S1037). A detailed example about the guide UI is described in FIG. 11.

If the user input for connecting to the terminal device 200 is not received (S1037-N), the electronic device 100 may repeat the steps S1005 to S1037.

If the user input for connecting to the terminal device 200 is received (S1037-Y), the electronic device 100 may transmit a signal for approving Wi-Fi P2P connection with the terminal device 200 to the terminal device 200 (S1038). The steps S1040 to S1070 may be performed.

FIG. 11 is a view illustrating an operation of displaying a guide UI for connecting an electronic device 100 and a terminal device 200.

With reference to FIG. 11, the electronic device 100 may display a guide UI 1110 for connecting the electronic device 100 and the terminal device 200. The guide UI may be a UI for guiding a user input to communicatively connect the electronic device 100 and the terminal device 200.

The guide UI may include at least one of text information 1111 indicating that the terminal device 200 requests connection, an image 1112 indicating communication connection between the electronic device 100 and the terminal device 200, or text information 1113 requesting the user input.

The image 1112 may include at least one of an icon of the electronic device 100, an icon of the terminal device 200, and a sign (or a character) indicating a communication method (e.g. Wi-Fi P2P).

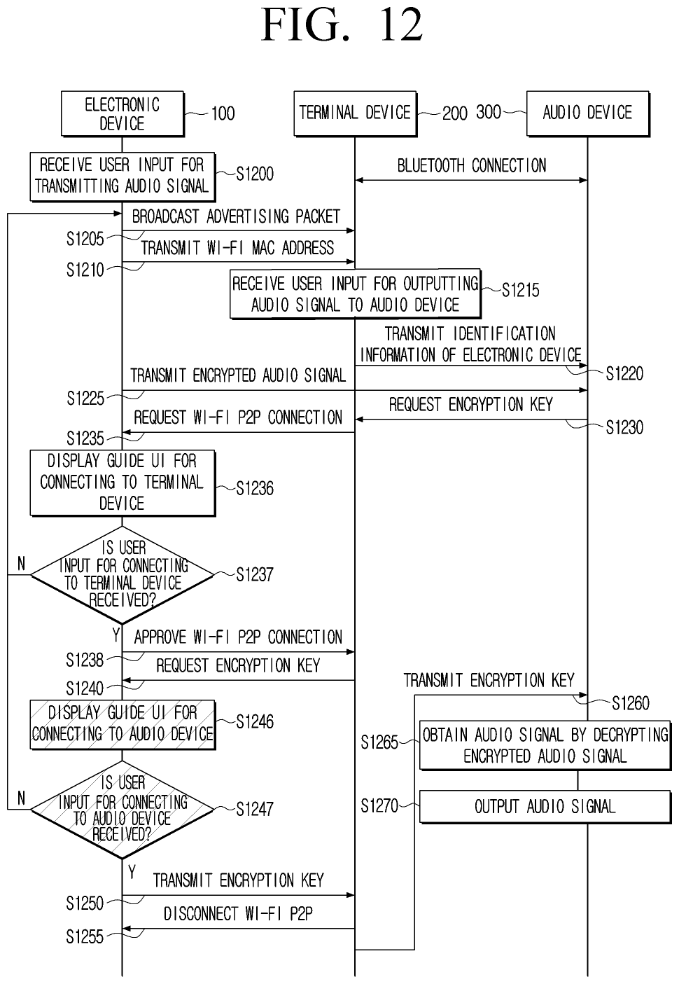

FIG. 12 is a flow chart illustrating an operation of displaying a guide UI for connecting an electronic device 100 and an audio device 300.

The steps S1200, S1205, S1210, S1215, S1220, S1225, S1230, S1235, S1236, S1237, S1238, S1240, S1245, S1250, S1250, S1255, S1260, S1265, S1270 of FIG. 12 may correspond to the steps S1000, S1005, S1010, S1015, S1020, S1025, S1030, S1035, S1036, S1037, S1038, S1040, S1045, S1050, S1050, S1055, S1060, S1065, S1070 of FIG. 10. For additional implementation details, reference may be made to the descriptions of FIG. 10.

If a request for an encryption key is received from a terminal device 200, the electronic device 100 may display a guide UI for connecting to the audio device 300 (S1246).

The electronic device 100 may identify whether a user input for connecting to the audio device 300 is received through the displayed guide UI (S1247). A detailed example about the guide UI is described in FIG. 13.

If the user input for connecting to the audio device 300 is not received (S1247-N), the electronic device 100 may repeat the steps S1205 to S1247.

If the user input for connecting to the audio device 300 is received (S1247-Y), the electronic device 100 may transmit the encryption key to the terminal device 200 (S1250). The steps S1255 to S1270 may be performed.

FIG. 13 is a view illustrating an operation of displaying a guide UI for connecting an electronic device 100 and an audio device 300.

With reference to FIG. 13, the electronic device 100 may display a guide UI 1310 for connecting the electronic device 100 and the audio device 300. The guide UI 1310 may be a UI for guiding a user input to communicatively connecting the electronic device 100 and the audio device 300.

The guide UI 1310 may include at least one of text information 1311 indicating that the audio device 300 requests connection, an image 1312 indicating communication connection between the electronic device 100 and the audio device 300, or text information 1313 requesting a user input.

The image 1312 may include at least one of an icon of the electronic device 100, an icon of the audio device 300, and a sign (or a character) indicating a communication method (e.g. BLE).

FIG. 14 is a flow chart illustrating an operation in which an audio device 300 outputs guide information.

The steps S1400, S1405, S1410, S1415, S1420, S1425, S1430, S1435, S1436, S1440, S1445, S1450, S1455, S1460, S1465, S1470 of FIG. 14 may correspond to the steps S700, S705, S710, S715, S720, S725, S730, S735, S736, S740, S745, S750, S755, S760, S765, S770 of FIG. 7. For additional implementation details, reference may be made to the descriptions of FIG. 7.

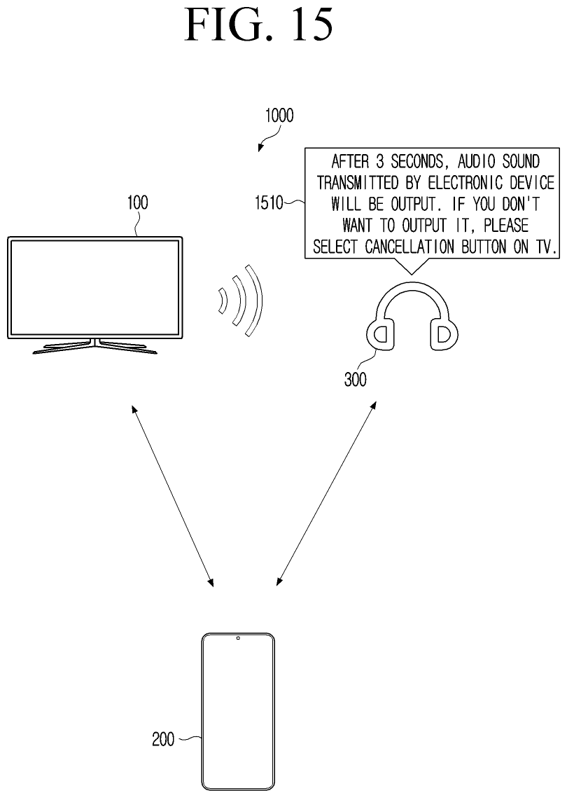

If the preset event occurs, the electronic device 100 may generate guide information (S1447). The electronic device 100 may transmit the encryption key and the guide information to the terminal device 200. The guide information may include information indicating that the audio signal is output by the audio device 300. If the audio device 300 suddenly outputs an audio signal, the user may be surprised. It may be notified to the user that the audio signal will be output right before the audio signal is output. An example related to the guide information is described in FIG. 15.

The terminal device 200 may receive the encryption key and the guide information from the electronic device 100. If the encryption key and the guide information are received from the electronic device 100, the terminal device 200 may transmit a signal for disconnecting Wi-Fi P2P to the electronic device 100 (S1455). If the encryption key and the guide information are received from the electronic device 100, the terminal device 200 may transmit the encryption key and the guide information to the audio device 300 (S1460).

The audio device 300 may receive the encryption key and the guide information from the terminal device 200. The audio device 300 may output the guide information in advance (S1461). The audio device 300 may perform the steps S1465 and S1470.

According to various embodiments, the audio device 300 may perform the step S1465 in advance and sequentially perform the step 1461 and the step S1470.

FIG. 15 is a view illustrating an operation in which an audio device 300 outputs guide information.

The system 1000 of FIG. 15 may include an electronic device 100, a terminal device 200, and an audio device 300. The audio device 300 may receive the encrypted audio signal, the encryption key, and the guide information. The audio device 300 may obtain the audio signal by decrypting the encrypted audio signal.

The audio device 300 may output guide information 1510 in advance before outputting the audio signal. The guide information 1510 may be information indicating that the audio signal transmitted by the electronic device 100 will be output by the audio device 300.

For example, the guide information 1510 may output audio sound “Audio sound transmitted by the electronic device will be output after 3 seconds. If you don't want to output it, please select a cancellation button on a TV.”

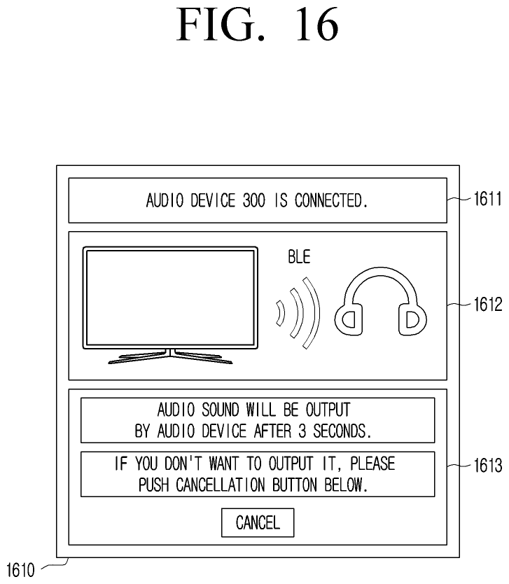

FIG. 16 is a view illustrating an operation in which an electronic device 100 outputs guide information.

With reference to FIG. 16, the electronic device 100 may display a UI 1610 related to connection between the electronic device 100 and the audio device 300. The UI 1610 may be a UI indicating that the audio signal is output by the audio device 300.

The UI 1610 may include at least one of text information 1611 indicating that the audio device 300 is connected, an image 1612 indicating communication connection between the electronic device 100 and the audio device 300, or guide information 1613 indicating an audio output.

The image 1612 may include at least one of an icon of the electronic device 100, an icon of the audio device 300, and a sign (or a character) indicating a communication method (e.g. BLE).

The guide information 1613 may include at least one of text information indicating that audio sound will be output by the audio device 300 (e.g. Audio sound will be output by the audio device after 3 seconds.) or text information for guiding a user input for output cancellation (e.g. if you don't want to output it, please push a cancellation button below).

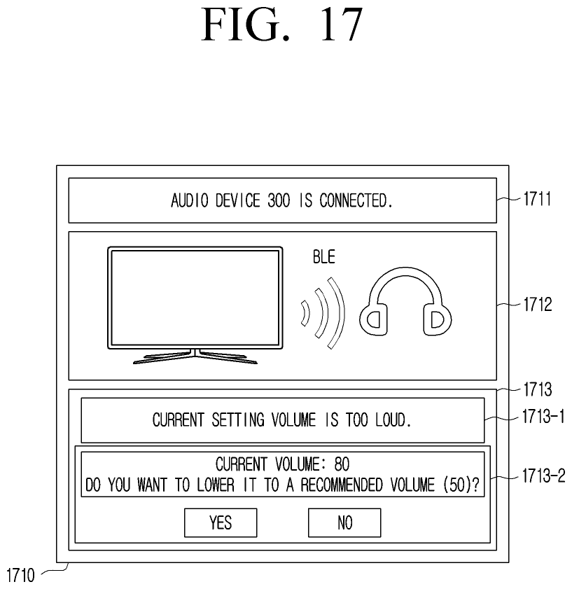

FIG. 17 is a view illustrating an operation related to volume control.

Text information 1711 and an image 1712 of FIG. 17 may correspond to the text information 1611 and the image 1612 of FIG. 16. For additional implementation details, reference may be made to the descriptions of FIG. 16.

An electronic device 100 may display a UI 1710. The UI 1710 may include volume control information 1713. The electronic device 100 may obtain a volume value of the audio device 300. The electronic device 100 may determine whether a volume value of the audio device 300 is equal to or greater than a threshold value. Here, the threshold value may mean a volume in which the user may feel that it is too loud. The threshold value may be varied according to a user setting.

If the volume value of the audio device 300 is equal to or greater than the threshold value, the electronic device 100 may display volume control information 1713. The volume control information may include at least one of text information that a volume set in the audio device 300 is too loud (1713-1) or text information of guiding to change a volume setting to a recommended volume value (1713-2).

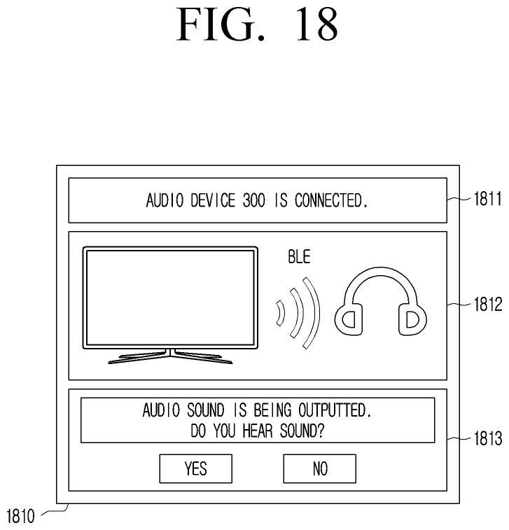

FIG. 18 is a view illustrating a UI related to connection of an audio device 300 according to various embodiments.

Text information 1811 and an image 1812 of FIG. 18 may correspond to the text information 1611 and the image 1612 of FIG. 16. For additional implementation details, reference may be made to the descriptions of FIG. 16.

An electronic device 100 may display a UI 1810. The UI 1810 may include feedback query information 1813.

The feedback query information 1813 may include text information for asking a user whether the audio device 300 normally outputs the audio signal. If the user inputs feedback information through the feedback query information 1813, the electronic device 100 may determine whether the audio signal provided by the electronic device 100 is normally output by the audio device 300.

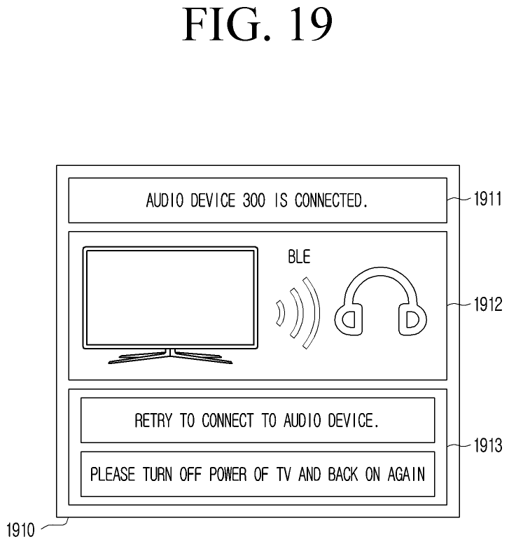

FIG. 19 is a view illustrating a UI related to connection of an audio device 300 according to various embodiments.

Text information 1911 and an image 1912 of FIG. 19 may correspond to the text information 1611 and the image 1612 of FIG. 16. For additional implementation details, reference may be made to the descriptions of FIG. 16.

An electronic device 100 may display a UI 1910. The UI 1910 may include problem solution information 1913.

If a user input that the audio device 300 does not normally output the audio signal is received through the feedback query information 1813 of FIG. 18, the electronic device 100 may obtain response information so that the audio device 300 normally outputs the audio signal. The electronic device 100 may display a UI 1910 including response information (e.g. Please turn on power of a TV and back on again) in the problem solution information 1913. The problem solution information 1913 may include text information indicating a retrial of an operation to connect to the audio device 300.

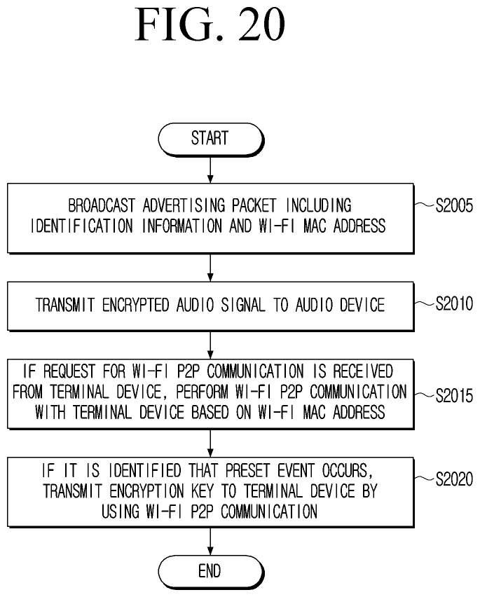

FIG. 20 is a flow chart illustrating a method of controlling an electronic device 100 according to various embodiments.

With reference to FIG. 20, a method of controlling an electronic device storing identification information of the electronic device, an encrypted audio signal, and an encryption key includes broadcasting an advertising packet including the identification information and a Wi-Fi MAC address (S2005), transmitting the encrypted audio signal to an audio device (S2010), if a request for P2P communication is received from a terminal device, performing the Wi-Fi P2P communication with the terminal device based on the Wi-Fi MAC address (S2015), and if it is identified that a preset event occurs, transmitting the encryption key to the terminal device by using the Wi-Fi P2P communication (S2020), wherein the encryption key is transmitted to the audio device through the terminal device, and wherein the encrypted audio signal is decrypted based on the encryption key.

The electronic device may include a BLE communication interface, wherein the transmitting the encrypted audio signal may include transmitting the encrypted audio signal to the audio device by using the BLE communication interface.

The control method may include, if the encryption key is transmitted to the terminal device, disconnecting the Wi-Fi P2P communication with the terminal device.

The encrypted audio signal may include an audio signal, wherein the audio signal is a signal output by the audio device after being obtained from the encrypted audio signal.

The control method may include transmitting the encryption key and sync data to the terminal device by using the Wi-Fi P2P communication, wherein the sync data is transmitted to the audio device through the terminal device, and wherein the audio signal is a signal output by the audio device based the sync data.

The control method may further include, if the request for Wi-Fi P2P communication is received from the terminal device, displaying a guide UI for enabling the Wi-Fi P2P communication with the terminal device, and if a user input is received through the guide UI, performing the Wi-Fi P2P communication with the terminal device based on the Wi-Fi MAC address.

The preset event may include at least one of an event that a user input for transmitting the encryption key is received, an event that the terminal device requesting the encryption key is a preregistered device, or an event that the terminal device is the preregistered device and the terminal device is within a threshold distance from the electronic device.

The control method may include, if a request for the encryption key is received from the terminal device, identifying whether the preset event occurs.

The control method may further include, if it is identified that the preset event occurs, generating guide information indicating that the audio signal is output by the audio device, and transmitting the generated guide information and the encryption key to the terminal device, wherein the guide information may be transmitted to the audio device through the terminal device.

The control method may further include displaying the guide information.

The control method of the electronic device such as FIG. 20 may be implemented on the electronic device 100 having configurations of FIGS. 2 and 3 and may be implemented on the electronic device 100 having other configurations.

The aforementioned methods, according to various embodiments, may be implemented in a form of an application installable in the existing electronic device.

The methods, according to various embodiments, may be implemented only with a software upgrade or a hardware upgrade with respect to the existing electronic device.

Various embodiments may be implemented through an embedded server included in the electronic device or an external server of at least one of the electronic device and the display device.

According to an embodiment, the various embodiments described above may be implemented as software including instructions stored in a machine (e.g. computer) readable storage medium, such as a non-transitory computer readable storage medium. The machine may refer to a device which calls instructions stored in the storage medium and is operable according to the called instructions, wherein it may include an electronic device according to the disclosed embodiments. If the instructions are executed by a processor, the processor may perform a function corresponding to the instructions directly or by using other components under control of the processor. The instructions may include a code generated or executed by a compiler or an interpreter. The machine readable storage media may be provided in a form of a non-transitory storage medium. Here, the term ‘non-transitory’ merely means that the storage media do not include a signal and are tangible, wherein the term does not distinguish a case that data is stored in the storage medium semipermanently from a case that data is stored in the storage medium temporarily.

According to an embodiment, the method according to the various embodiments described above may be provided to be included in a computer program product. The computer program product may be traded between a seller and a buyer as goods. The computer program product may be distributed in a form of a machine readable storage medium (e.g. compact disc read only memory (CD-ROM)) or may be on-line distributed via an application store (e.g. play store™). In the case of on-line distribution, at least part of the computer program product may be stored at least temporarily or may be generated temporarily in a storage medium such as memory of a server of a manufacturer, a server of an application store, or a relay server.

Each of components (e.g. a module or a program) according to the various embodiments above may be configured as a single item or a plurality of items, wherein another subcomponent may be further included in various embodiments. Some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, at least part of the operations may be executed in different orders, or another operation may be added.

Various embodiments of the disclosure are shown and described. The disclosure is not limited to the aforementioned embodiments, and various modifications may be implemented by those skilled in the art without deviating from the spirit or scope of the disclosure.

What is claimed is:

1. An electronic device comprising:
a communication interface configured to communicate with a terminal device and an audio device;
one or more processors; and
memory storing instructions that, when executed by the one or more processors, cause the electronic device to:
broadcast, via the communication interface, an advertising packet comprising identification information of the electronic device and a Wi-Fi MAC address;
transmit, via the communication interface, an encrypted audio signal, to the audio device;
based on receiving, via the communication interface, a request for Point-to-Point (P2P) from the terminal device, perform, via the communication interface, the P2P communication with the terminal device based on the Wi-Fi MAC address; and
based on identifying a preset event has occurred for enabling transmission of an encryption key of the electronic device, transmit, via the communication interface, the encryption key to the terminal device by using the P2P communication, to cause the terminal device to transmit the encryption key to the audio device and to cause the audio device to decrypt the encrypted audio signal based on receiving the encryption key.

2. The electronic device of claim 1, wherein the communication interface comprises a Bluetooth Low Energy (BLE) communication interface, and
wherein the instructions, when executed by the one or more processors, cause the electronic device to transmit the encrypted audio signal to the audio device via the BLE communication interface.

3. The electronic device of claim 1, wherein the instructions, when executed, by the one or more processors, cause the electronic device to, based on the encryption key being transmitted to the terminal device, disconnect, via the communication interface, the P2P communication with the terminal device.

4. The electronic device of claim 1, wherein the instructions, when executed by the one or more processors, cause the electronic device to transmit the encryption key to the terminal device, to cause the terminal device to transmit the encryption key to the audio device and to cause the audio device to decrypt the encrypted audio signal and output the decrypted audio signal based on receiving the encryption key.

5. The electronic device of claim 4, wherein the instructions, when executed by the one or more processors, cause the electronic device to transmit the encryption key and sync data to the terminal device via the P2P communication, to cause the terminal device to transmit the sync data to the audio device and to cause the audio device to output the decrypted audio signal based on the sync data.

6. The electronic device of claim 1, wherein the electronic device further comprises a display, and
wherein the instructions, when executed by the one or more processors, cause the electronic device to:
based on identifying the request for the P2P communication has been received by the terminal device, output, via the display, a User Interface (UI) for enabling the P2P communication with the terminal device; and
based on a user input being received via the UI, perform the P2P communication, via the communication interface, with the terminal device based on the Wi-Fi MAC address.

7. The electronic device of claim 1, wherein the preset event comprises at least one of:
a user input for transmitting the encryption key being received,
identifying that the terminal device is a preregistered device, or
identifying that the terminal device is the preregistered device and that the terminal device is within a preset distance from the electronic device.

8. The electronic device of claim 1, wherein the instructions, when executed by the one or more processors, cause the electronic device to, based on a request for the encryption key being received from the terminal device, identify whether the preset event occurs.

9. The electronic device of claim 4, wherein the instructions, when executed by the one or more processors, cause the electronic device to:
based on identifying the preset event has occurred, generate guide information for the decrypted audio signal; and
transmit, via the communication interface, the guide information and the encryption key to the terminal device, to cause the terminal device to transmit the guide information to the audio device.

10. The electronic device of claim 9, wherein the electronic device further comprises a display, and
wherein the instructions, when executed by the one or more processors, cause the electronic device to output the guide information via the display.

11. A method of controlling an electronic device storing identification information of the electronic device, an encrypted audio signal, and an encryption key, the method comprising:
broadcasting an advertising packet comprising the identification information and a Wi-Fi MAC address via a communication interface of the electronic device;
transmitting the encrypted audio signal to an audio device via the communication interface;
based on a request for Point-to-Point (P2P) communication being received from a terminal device, via the communication interface, performing the P2P communication with the terminal device based on the Wi-Fi MAC address; and
based on identifying a preset event has occurred for enabling transmission of the encryption key, transmitting the encryption key to the terminal device via the P2P communication, to cause the terminal device to transmit the encryption key to the audio device and to cause the audio device to decrypt the encrypted audio signal based on receiving the encryption key.

12. The method of claim 11, wherein the electronic device includes a Bluetooth Low Energy (BLE) communication interface, and
wherein the transmitting the encrypted audio signal comprises transmitting the encrypted audio signal to the audio device via the BLE communication interface.

13. The method of claim 11, further comprising, based on identifying the encryption key has been transmitted to the terminal device, disconnecting the P2P communication with the terminal device.

14. The method of claim 11, wherein the transmitting the encrypted audio signal comprises transmitting the encryption key to the terminal device, to cause the terminal device to transmit the encryption key to the audio device and to cause the audio device to decrypt the encrypted audio signal and output the decrypted audio signal based on receiving the encryption key.

15. The method of claim 14, wherein the transmitting the encrypted audio signal comprises transmitting the encryption key and sync data to the terminal device via the P2P communication, to cause the terminal device to transmit the sync data to the audio device and to cause the audio device to output the decrypted audio signal based on the sync data.
